(19) United States
(12) Patent Application Publication
(10) Pub. No.: US 2025/0260127 A1
(43) Pub. Date: Aug. 14, 2025

(54) ANODE-OVERLAP BATTERY

(71) Applicant: FORD GLOBAL TECHNOLOGIES, LLC, Dearborn, MI (US)

(72) Inventors: Hyukkeun Oh, Ann Arbor, MI (US); Xin Liu, Novi, MI (US); Ali Rashti, Canton, MI (US)

(21) Appl. No.: 18/439,900

(22) Filed: Feb. 13, 2024

(51) Int. Cl. H01M 50/46; H01M 4/04; H01M 50/414

(52) U.S. Cl. CPC H01M 50/461; H01M 4/0435; H01M 50/414

(57) ABSTRACT

A battery for an electrified vehicle is made from a stack of battery cells having an anode overlap design. A second electrically insulating material is printed on the separator before the cathode is compressed in the anode/separator layer. This second material penetrates any cracks that may form during the compression.

### TECHNICAL FIELD

The present disclosure relates to a battery, such as a battery for an electrified vehicle. More particularly, the disclosure relates to an anode-overlap battery in which a second insulating material is applied to the separator prior to compression to fill cracks in the separator.

### BACKGROUND

An electrified vehicle uses electric power stored in a battery for propulsion instead of or in addition to an internal combustion engine. Some electrified vehicles utilize a battery having battery cells with an anode-overlap design in which the anode and separator are larger than the cathode such that a portion of the anode and separator extend beyond an edge of the cathode. In a solid-state battery, the separator may be a rigid inorganic material. During compression of such a solid-state battery, anode-overlap cells are subject to formation of cracks in the separator around the edge of the cathode.

### SUMMARY

A battery cell includes an anode, a cathode, a separator made of a first electrically insulating material compressed between the anode and the cathode to form an anode overlap configuration in which the cathode is recessed into the separator, the separator having cracks around an edge of the cathode, and a second electrically insulating material along the edge of the cathode and penetrating the cracks in the separator.

A process for manufacturing a battery includes adhering a separator to an anode to form an anode/separator layer, the separator made of a first electrically insulating material, a surface of the separator opposite the anode defining an inner region in a shape of a cathode and an outer region, applying a second electrically insulating material to the outer region, and compressing the cathode into the anode/separator layer resulting in formation of cracks around an edge of the cathode and penetration of the cracks by the second material.

A battery comprising a plurality of cells compressed into a stack, each cell comprising an anode, a cathode, a separator made of a first electrically insulating material compressed between the anode and the cathode to form an anode overlap configuration, wherein the separator has an outer region extending beyond an edge of the cathode, and a second electrically insulating material along the outer region of the separator on a surface facing the cathode, the second material penetrating cracks in the separator.

### BRIEF DESCRIPTION OF THE DRAWINGS

FIG. 1 is a block diagram of a vehicle for an electrified vehicle.

FIG. 2 is a profile view of an anode, a separator, and a cathode for a battery cell of the battery of FIG. 1.

FIG. 3 is a cross-sectional view of the anode, separator, and cathode of FIG. 2 during a stage of fabrication of the battery cell prior to compression.

FIG. 4 is a cross-sectional view of the battery cell after compression.

FIG. 5 if a profile view of an anode/separator layer according to a revised manufacturing process.

FIG. 6 is a cross sectional view of the anode/separator layer and cathode during a stage of the revised manufacturing process prior to compression.

FIG. 7 is a cross sectional view of the battery cell manufactured according to the revised process after compression.

FIG. 8 is a flow chart of the revised manufacturing process.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

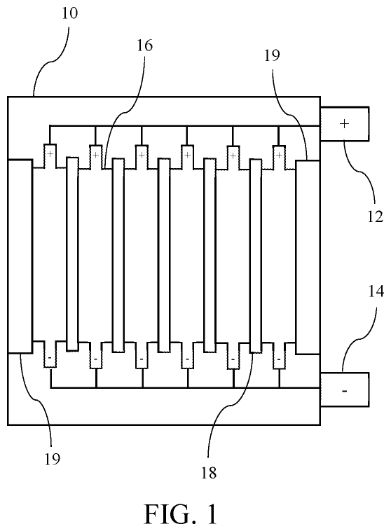

Referring to FIG. 1, a battery 10, such as a traction battery for an electrified vehicle, provides an electrical potential (voltage) between a positive terminal 12 and a negative terminal 14. The battery includes a stack of battery cells 16. The illustrated embodiment includes six cells but the number may vary. Each cell includes an anode, a cathode, and a separator. Each cell has a positive terminal and a negative terminal, which are electrically connected to the positive terminal 12 and the negative terminal 14 of the battery. In the illustrated embodiment, the cells are connected in parallel such that the voltage of the battery is equal to the voltage provided by each cell. In other embodiments, some cells may be connected to one another in series such that the voltage of the battery exceeds the voltage of individual cells. An insulator 18 is inserted between adjacent cells. Pressure plates 19 on each end of the stack of cells are arranged to compress the cells together. A pressure in the range of 10 MPa may be typical.

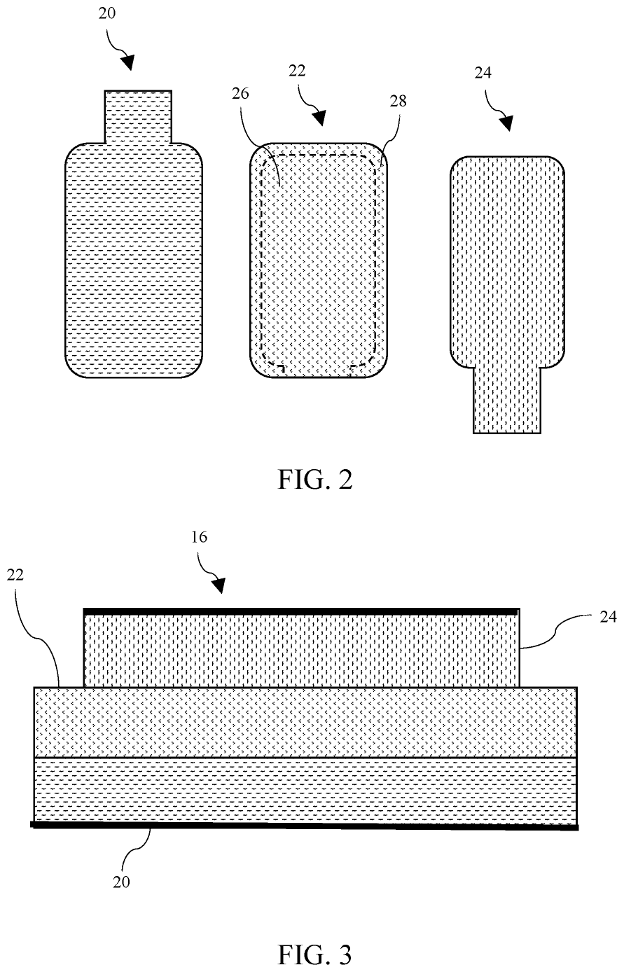

FIG. 2 illustrates the anode 20, the separator 22, and the cathode 24 of one of the battery cells 16. In particular, these components form an anode-overlap type of solid-state battery cell. Note that the anode 20 and the separator 22 are slightly larger than the cathode, such that they overlap the cathode when the components are stacked together with the separator between the anode and the cathode. Two regions of the top surface of separator 22 can be defined. An inner region 26 will be in contact with the cathode after assembly. An outer region 28 will extend beyond the edges of the cathode after assembly.

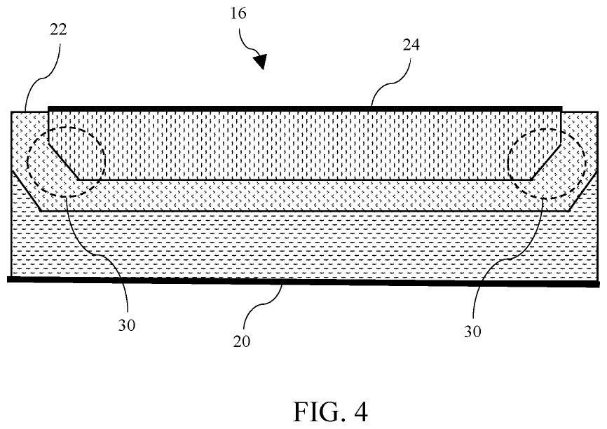

FIGS. 3 and 4 illustrate the battery cell at two stages of the assembly process. FIG. 3 is a cross-sectional view of the components before they are compressed. FIG. 4 is a cross-sectional view of the components after they are compressed. Cracks may form in the separator 22 in the vicinity 30 of the edge of the cathode. Short circuiting can occur during compression if the cathode and the anode outer edge come in contact through the cracks, in the case when the cathode effectively punches through the separator. When pressure is removed, the compressed area slightly springs back, which can allow debris to enter. The cracks and debris can cause short circuiting even after pressure is removed, because loose conductive particles can form a transport channel for electrical current. Even if the cathode and anode are not in electrical contact after pressure is removed, the shorter distance between them allows higher current density leading to lithium plating and dendrite growth, which can easily occur through the cracks with lesser mechanical resistance and result in short circuiting during cycling of the battery.

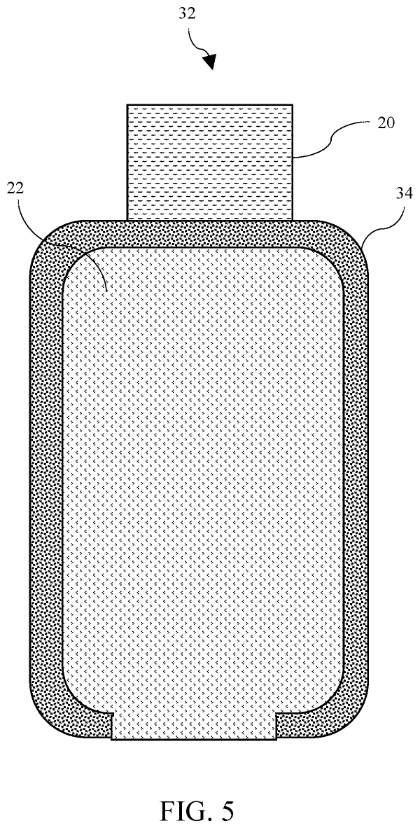

FIG. 5 illustrates an anode/separator layer 32 produced according to a revised fabrication process designed to alleviate the short-circuiting described above. Separator 22 has been adhered to the anode 20. Additionally, a second electrically insulating material 34 has been applied over the outer region 28 of the surface of the separator 22 opposite the anode. The second material may be a gel or may be a resin such as epoxy resin. The second material may be applied, for example, using a printed process.

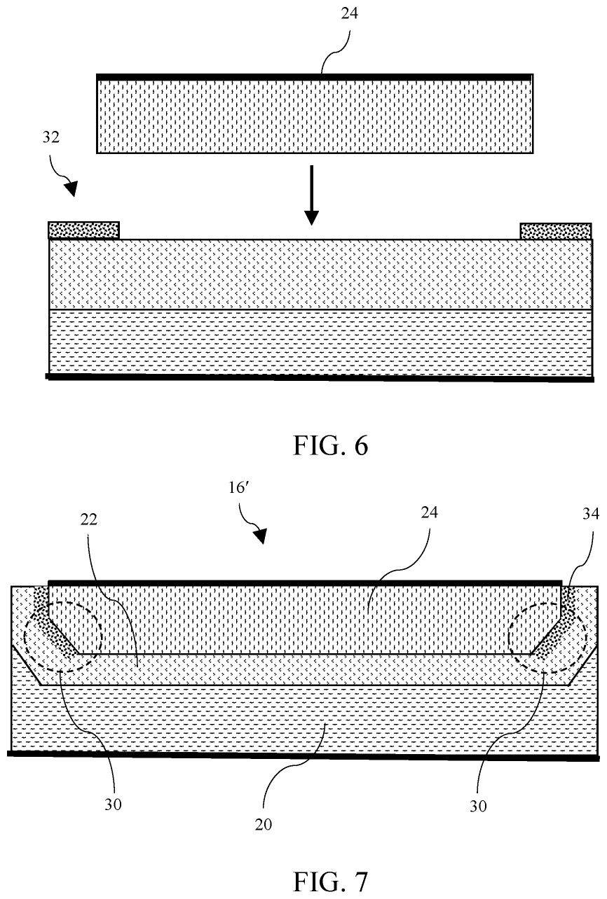

FIGS. 6 and 7 illustrate stages of assembly of a battery cell 16′ according to the revised fabrication process. As shown in FIG. 6, the cathode is placed over the separator. Notice that some of the second material overlaps with the cathode. In other words, in addition to covering the outer region of the separator, the second material may also be applied to a portion of the inner region that is adjacent to the outer region. As shown in FIG. 7, the second material flows around the vicinity 30 of the edge of the cathode during compression. If cracks form in the separator layer, the second material tends to permeate into these cracks. The second material, when permeated into the cracks, can effectively prevent short circuiting happening between the anode and cathode. Even after the assembly, the non-uniform current density leading to dendrite growth and short-circuiting during cycling can be significantly suppressed by blocking all electrical currents and ionic transport passing in the vicinity of the cathode edge area.

The second electrically insulating material could be either a resin or a gel-type. While the gel system could allow a wider variety of material combinations for different viscosity and modulus designs, a resin system has the advantage of simplicity and less concern of the drying process for the gel medium solvent after printing, since the liquid components are cured spontaneously by cross-linked polymerization. Epoxy resin, as an electrically and ionically insulating material, is known to have a wide range of viscosity as uncured that can be achieved with different type of blends and additives, typically from 100 cps to 1.5 Mcps. The modulus as-cured can be adjusted as well, with different types of blends and additives. The curing rate of epoxy typically is known to be faster at elevated temperatures, which can be utilized for high-speed manufacturing.

With a gel solvent which has similar polarity to the solvent and binder of the battery layers, a low-solvent, high-viscosity gel would be most desirable in order to prevent excessive redissolution of the separator and cathode binders by the solvent, and the expected outcome would be a low-permeation, high-strength protection in the edges of the cathode. With a high-viscosity gel, wettability of the particles must be ensured for sufficient permeation, and whether crack formation is exacerbated because of the gel under the applied pressure needs to be checked. On the other hand, with a gel material which has very different polarity of the solvent and polymeric material than the binder, a high-solvent, low-viscosity gel can be used which will allow high-permeation of the gel across the layers and thus protection over a larger portion of the battery, because there is less concern on the redissolution of the separator and cathode binders. Possibility of redissolution of the ceramic or glass-ceramic separator electrolyte material also must be taken into consideration, because dissolution and recrystallization can negatively affect the ionic conductivity of the solid-state electrolyte. If there is a concern on the mechanical strength of the gel in terms of dendrite growth prevention, thermal or radiation curing can be considered, with the use of crosslinking agents in the gel solution.

Pre-calendaring the cathode and separator/anode laminated layer 32 before printing and final compression reduces the porosity of the electrode layers and suppresses permeation of the insulator into the active area. Typically, after lamination of the separator to the anode, in which a pressure of ˜100 MPa is applied to attach the two layers together, the porosity of the layers is already reduced to ˜10%. By pre-calendaring the cathode 24 before attaching to the separator/anode laminated layer 32 or further reducing the porosity of the separator/anode laminated layer 32 with higher pressure (>100 MPa), permeation can be controlled to occur mostly into the outer edge area which becomes slightly more porous than the inner region during the compression step. This prevents the second insulating material from significantly blocking electrical and ionic transport in the active area of the cell.

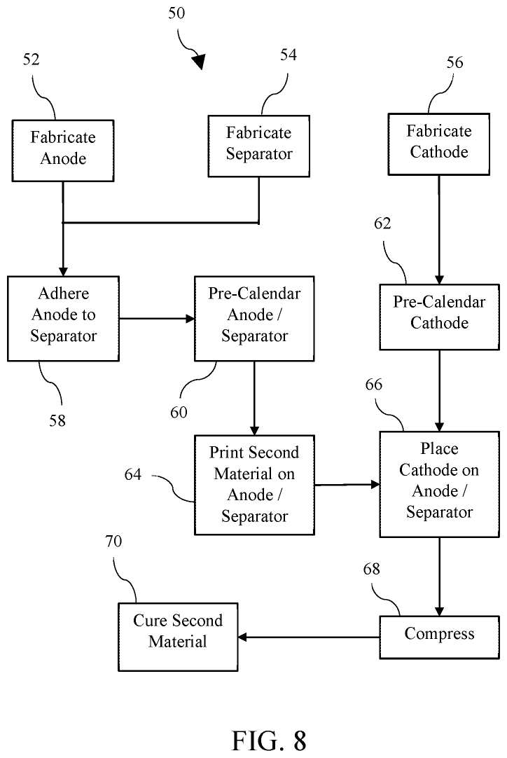

FIG. 8 is a flowchart describing the revised process 50. Some steps may be optional. At 52, 54, and 56, the anode 20, separator 22, and the cathode 24, respectively, are fabricated using conventional methods. At 58, the anode 20 is attached to the separator 22 to form an anode/separator layer 32. At 60 and 62, the anode/separator layer 32 and the cathode 24, respectively, are pre-calendared to reduce the porosity of the electrode layers and suppress permeation of the low-viscosity insulator into the active area. At 64, the second material is applied, such as by printing, to the outer region of the separator. The second material may also be applied to a portion of the inner region adjacent to the outer region. At 66, the cathode 24 is placed on the anode/separator layer 32 such that it contacts the entire inner region but not the outer region. At 68, assembly is compressed, preferably to a pressure of at least 300 MPa, with 400-500 MPa being typical. At 70, the second material is cured. For example, it may be exposed to an elevated temperature or to radiation.

While exemplary embodiments are described above, it is not intended that these embodiments describe all possible forms encompassed by the claims. Other topologies and variations are, of course, contemplated.

The words used in the specification are words of description rather than limitation, and it is understood that various changes may be made without departing from the spirit and scope of these disclosed materials.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A battery cell comprising:
an anode;
a cathode;
a separator made of a first electrically insulating material compressed between the anode and the cathode to form an anode overlap configuration in which the cathode is recessed into the separator, the separator having cracks around an edge of the cathode; and
a second electrically insulating material along the edge of the cathode and penetrating the cracks in the separator.

2. The battery cell of claim 1 wherein the second electrically insulating material is a gel.

3. The battery cell of claim 2 wherein the gel has a solvent with a different polarity than a binder of the separator.

4. The battery cell of claim 1 wherein the second electrically insulating material is a resin.

5. The battery cell of claim 4 wherein the resin is an epoxy resin.

6. A process for manufacturing a battery comprising:
adhering a separator to an anode to form an anode/separator layer, the separator made of a first electrically insulating material, a surface of the separator opposite the anode defining an inner region in a shape of a cathode and an outer region;
applying a second electrically insulating material to the outer region; and
compressing the cathode into the anode/separator layer resulting in formation of cracks around an edge of the cathode and penetration of the cracks by the second electrically insulating material.

7. The process of claim 6 wherein compressing the cathode into the anode/separator layer comprises applying a pressure exceeding 300 MPa.

8. The process of claim 6 wherein the second electrically insulating material is a gel.

9. The process of claim 8 wherein the gel has a solvent with a different polarity than a binder of the separator.

10. The process of claim 6 wherein the second electrically insulating material is a resin.

11. The process of claim 10 wherein the resin is an epoxy resin.

12. The process of claim 6 further comprising curing the second electrically insulating material after compressing.

13. The process of claim 6 wherein the second electrically insulating material is also applied to a portion of the inner region adjacent to the outer region.

14. The process of claim 6 further comprising:
pre-calendaring the anode/separator layer before applying the second electrically insulating material; and
pre-calendaring the cathode before compressing the cathode into the anode/separator layer.

15. The process of claim 6 wherein the second electrically insulating material is applied by printing.

16. A battery comprising a plurality of cells compressed into a stack, each cell comprising:
an anode;
a cathode;
a separator made of a first electrically insulating material compressed between the anode and the cathode to form an anode overlap configuration, wherein the separator has an outer region extending beyond an edge of the cathode; and
a second electrically insulating material along the outer region of the separator on a surface facing the cathode, the second electrically insulating material penetrating cracks in the separator.

17. The battery of claim 16 wherein the cells are compressed with a pressure exceeding 10 MPa.

18. The battery of claim 16 wherein the second electrically insulating material is a gel.

19. The battery of claim 16 wherein the second electrically insulating material is a resin.
